(19) United States
(12) Patent Application Publication
(10) Pub. No.: US 2012/0040042 A1
(43) Pub. Date: Feb. 16, 2012

(54) Composite Mold with Expandable Boot

(76) Inventors: Maurice Guitton, Lunenburg (CA); Tim Aulenback, Mahone Bay (CA); Mike Davison, Lunenburg (CA); Claude Baril, Laval (CA); Severine Guitton, Lunenburg (CA); Kevin Steck, Puyallup, WA (US); Paul Bruhm, Mahone Bay (CA); Mike Myra, Lunenburg (CA)

(21) Appl. No.: 13/016,757

(22) Filed: Jan. 28, 2011

Related U.S. Application Data
(60) Provisional application No. 61/299,320, filed on Jan. 28, 2010.

(51) Int. Cl. B28B 7/30

(52) U.S. Cl. 425/468

(57) ABSTRACT

An improved mold for molding composite structures inside the closed cavity of the mold that uses a projecting tool member, a compression plate and at least two side plates located inside an expansion cavity formed in the mold. The mold includes a base made up of two mold sections that when jointed form a partially enclosed mold cavity. Located over the mold cavity are two side plates each with an inside beveled edge. The side parts are aligned inside the expansion cavity so that the two beveled edges are adjacent a form a large V-shape void. The compression plate includes a V-shaped projection that fits into the V-shaped void. The improvement includes a U-shaped, heat expandable boot located between the inside surfaces of the projecting tool member, the inside surfaces of the two side plates, and the inside surfaces of the mold that evenly distributes the external forces and evenly distributes the forces created by expansion during the curing stage to product structures with uniform side walls.

This is a utility patent application based on U.S. Provisional patent application (Application No. 61/299,320) filed on Jan. 28, 2010.

### BACKGROUND OF THE INVENTION

1. Field of the Invention

This invention pertains to closed molds used for manufacturing molded composite structures using heat and pressure or heat only.

2. Description of the Related Art

In some industries, parts and structures with different surfaces, flanges, connecting joints, and different wall thickness that were once made of metal are now made of lightweight composite material. Like metal parts or structures, composite parts or structures must be precisely manufactured. Unfortunately, designing molds and molding methods that reliably produce complex composite parts or structures is difficult. It can be especially difficult when different types of composite materials may be used, and when the curing step may use variable amounts of heat and pressure.

C-shaped or channel-shaped composite structures are commonly manufactured in a closed mold that includes an outside mold section and an inside mold section. When the two mold sections are joined together, an internal mold cavity is created which is then filled with uncured composite material. As the composite material cures inside the mold cavity, different areas on the composite structure cure and expand at different rates and amounts, thereby creating composite structures that may deviate from their desired specifications.

There are several types of closed molds used today to manufacture composite structures using heat and pressure. One type of closed mold is made up of two or more mold sections which are used to form the straight and curved surfaces of the composite structure. Each mold section includes a partially enclosing expansion cavity. Located inside the expansion cavity are two L or V-shaped side plates. The side plates are aligned inside the expansion cavity so that one leg on each side plate faces inward. A beveled edge is formed on the inward directed leg thereby forming an V-shaped void. Disposed over the inside surface of the horizontal legs on the two side plates is a flat compression plate. The compression plate includes a V-shaped projection that fits into and presses against the V-shaped void formed by the two mold sections. When downward pressure is exerted on compression plate, the V-shaped projection is forced into the V-shaped void causing the two side plates to separate and move laterally inside the expansion cavity.

Disposed over the compression plate and over the upper ends of the two side plates is a protruding tool member. The protruding tool member extends into the mold cavity and presses downward against the compression plate and between the two mold sections. A cap plate is then positioned over the exposed surface on the protruding tool member.

After assembly, uncured composite material is dispensed into a mold cavity created in the expansion cavity between the inside surfaces of the two mold sections and the outside surfaces of the two side plates. After the mold as been assembled and heat and external pressure is applied to the two mold sections and to the cap plate, the protruding tool member is forced against the compression plate and the composite material begins to expand. During the curing step, the composite material may expand causing the side plates to move at different rates and at different amounts. The only force resisting movement of the side plates is the pressure exerted by the compression plate.

What is needed is an improved closed mold for manufacturing composite structures that uses a compression plate and projecting tool core that the external pressure and expansion pressures to be more evenly distributed thereby producing cured composite structures with fewer defects.

### SUMMARY OF THE INVENTION

Disclosed herein is a mold and method of molding composite structures inside the closed cavity of the mold that uses a heat expandable boot that can be manufactured in different shapes and thickness using heat and external pressure or heat only.

In the first embodiment, the mold includes a base made up of two mold sections that when jointed form a partially enclosed mold cavity. Located inside the mold cavity are two L-shaped side parts. Each side part includes a horizontal leg and a vertical or diagonal le with an inward directed beveled edge. The two side parts are aligned inside the mold cavity so that the two beveled edges are adjacent a form a large V-shape void. Located above the two horizontal legs is a compression plate with a downward extending V-shaped projection designed to slidingly engage the V-shaped void.

A U or C-shaped expansion boot is then placed inside the expansion cavity with its horizontal section extending over the compression plate. The outer legs of the boot extend upward and parallel to the vertical or diagonal legs of the side plates. Formed inside the expansion boot is a intermediate cavity. A tool core is inserted into the intermediate cavity with its perimeter surfaces positioned against the inside surface of the boot. A cap plate is then placed over the top ends of the base and over the tool core and the ends of the boot.

During use, heat and external pressure is applied to the cap plate and mold sections. During the curing step, the composite material expands causing the side plates to move at different rates and at different amounts. The protruding tool core presses against the inside surfaces of the boot compression thereby resisting movement in every direction.

In a second embodiment, a second mold is used to manufacture a C-shaped composite structure that uses a tool core positioned against the composite material with the expandable boot positioned between the composite material and inside surface of the base.

In both embodiments, when the boot is placed inside the mold cavity, the boot applies evenly distributed pressure against the composite part as the mold is heated or when heated and pressurized. In the first embodiment, the boot may be positioned between the tool core and the composite plate. In the second embodiment, the boot is positioned between the composite part and the inside surface of the mold parts. In both embodiments, the boot is able to partially absorb and transfer forces to form composite structures with uniform shape and thickness.

An optional grid layer may be placed between the boot and the composite cavity that during the curing process, imparts a desirable smoothness or textured pattern on the composite part after curing.

### DESCRIPTION OF THE DRAWINGS

FIG. 1 is sectional side elevational view of a mold with an internal mold cavity used to manufacture a C-shaped composite structure made of composite material that is cured with heat and external pressure that uses an expandable boot to located between a tool core and three internal movable tool parts that are designed to evenly apply and distribute pressures against the composite structure, the tool core, the tool parts so that the composite part structure has the desired shape.

FIG. 2 is a sectional side elevational view of a second mold also used to manufacture a C-shaped composite structure made of composite material that cured with heat only that uses a tool core positioned against the composite material with the expandable boot positioned between he composite material and inside surface of the mold base with an optional grid layer located between the composite layer and the boot.

### DESCRIPTION OF THE PREFERRED EMBODIMENT(S)

Disclosed herein is a mold 10, 60 used to manufacture a C or channel shaped composite structure 50, 100, respectively, that has uniform thickness and less defects. The mold 10, 60 includes an expansion cavity which an expandable boot is placed and used to evenly distributed external pressures and expansion pressure when the mold is heated or when heated and pressurized.

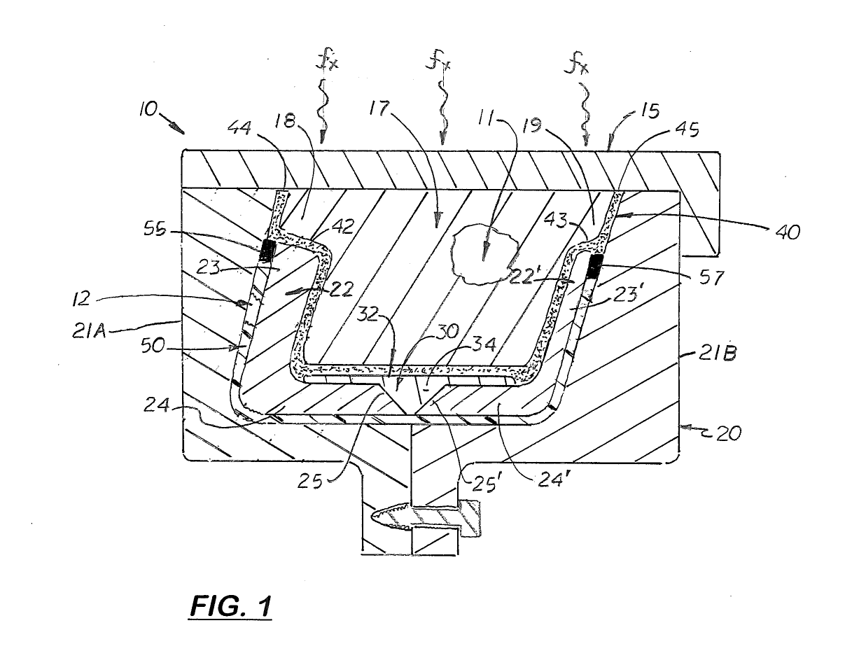

FIG. 1 is sectional side elevational view of a first mold embodiment, indicated by the reference number 10, with an internal mold cavity 12 formed in an expansion cavity formed in a base 20 that is used to manufacture a C-shaped composite structure 50. The base 20 is made of at least two mold parts 21A, 21B held together with a suitable connector 22. Formed in the base 20 is an expansion cavity 11. The mold 10 includes a cap plate 15 that extends across the expansion cavity 11 and supported by the bases upper flat surfaces. Located under the cap plate 15 is a tool core 17 designed to downward extend into the expansion cavity 11

Located inside the expansion mold cavity 11 are two side parts 22, 22′. The side parts 22, 22′ are L or C shaped form a L or C shaped mold cavity 12 located between them and the insides surfaces of the two mold parts 21A, 21B. After assembly, the side plates 22, 22′ are able to move inward and outward along the inside surfaces of the mold parts 21A, 21B according to the balanced forces exerted on them by an external pressure source (indicated by the reference letter fx) applying pressure to the cap plate 15 and by the inward expansion pressure exerted by the composite material located in the mold cavity 12 when curing.

Each side part 22, 22′ includes a vertical leg 23, 23′ and a horizontal leg 24, 24′, respectively. Formed on the distal end of each horizontal leg 23, 23′ is a beveled edge 25, 25′, respectively. The length of the vertical legs 23, 23′ is less than the height of the mold part 21A, 21B, respectively. During assembly, the two side parts 22, 22′ are positioned inside the expansion cavity 11 so that the vertical legs 23, 23′ are aligned parallel to the two inside walls of the adjacent mold parts 21A, 21B and the horizontal legs 24, 24′ are aligned parallel to the inside bottom surface of the two mold parts 21A, 21B. The relative shaped and size of the side parts 22, 22′ depend on the shape and size of the composite structure and the structure's side wall thickness. When assembled, the horizontal legs 23, 23′ extend inward and the two beveled edges 25, 25′ together form a central, V-shaped void 30.

Disposed over the inside surfaces of the two side parts 22, 22′ is a flat compression plate 32. The compression plate 32 includes a downward extending, V-shaped projection 34 that fits into and presses against the V-shaped void 30 formed by the two side parts 22, 22′. By raising and lowering the compression plate 32 over the two side plates 22, 22′, the V-shaped projection 34 disengages and engages the V-shaped void 30 and thereby enables or forces the two side parts 22, 22′ to move inward and outward in the expansion cavity 11.

Disposed over the top surface of the compression plate 32 and over the inside surfaces of the vertical legs 23, 23′of the two side parts 22, 22′, respectively, is an expandable boot 40. The boot 40, which is made of silicone, is a C-shaped in cross-section and similar to the shape to the mold cavity 12 formed between the base 20 and the two side parts 22, 22′. Formed on the boot 40 are two outward extending legs 42, 43 that bend and extend over the upper ends of the two side plates 22, 22′. The ends of the boot 40 bend upward and are positioned adjacent to the upper sections of the mold parts 21A, 21B. The distal ends 44, 45 of the boot 40 terminate at the cap plate 15.

During assembly, the cap plate 15 is placed over the base 20. Located below the cap plate 15 is a tool core 17. The lower surface of the tool core 17 is complimentary in shaped to the boot 40 when formed and placed over the side parts 22, 22′ so that it presses tightly against the boot 40. The tool core 17 includes two outer extending lips 18, 19 that press against the two extending legs 42, 43, respectively, on the boot 40 forcing them outward.

In the embodiment shown in FIG. 1, optional plugs 55, 57′ are positioned on the top of the mold cavity 12 that act to limit the expansion of the composite structure 50 and to restrict outward expansion of the two side plates 22, 22′. The plugs 55, 57 are made of low expansion material, such as metal or glass and have a suitable thickness or diameter equal to the desired thickness of the composite structure 50.

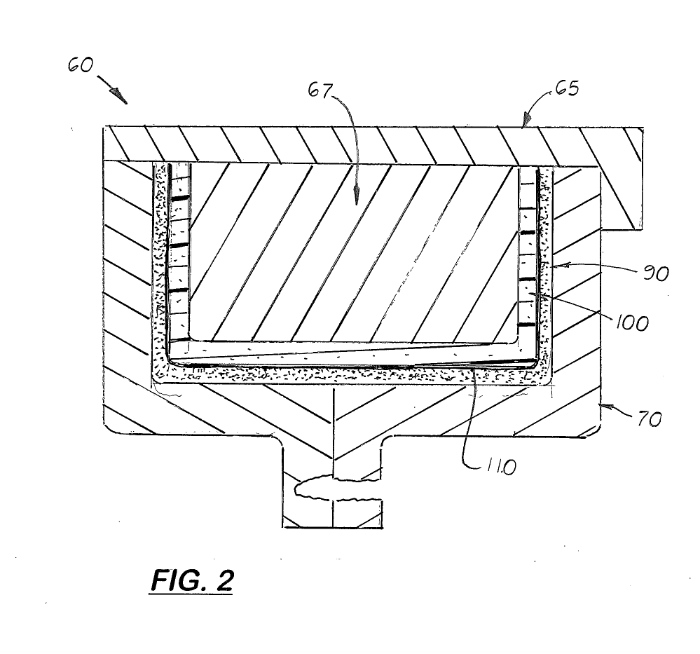

FIG. 2 shows a second embodiment of the mold 60 that is also used to manufacture a a C-shaped composite structure 100 made of composite material cured with heat only. With this embodiment, the tool core 67 positioned against the composite structure 100 and the expandable boot 90 is positioned between he composite structurre 100 and inside surface of the base 70. Because pressure is not used, the amount of expansion of the composite structure 100 is less than the composite structure 50 formed using the first mold 10 and method. Also, an optional grid or laminate layer 110 may be located between the composite structure 100 and the boot 90 to produce an desired smoothness or textured pattern on the surfaces of the composite structure 100.

The boot 40, 90 is made of silicone or polyurethane approximately 2 to 8.0 mm thick and expands 10 to 30%. The actual material selected for the boot 40, 90 and the thickness of the boot used depends on the type of composite material used and the general shape of the composite structure 100.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

We claim:

1. An improved mold for manufacturing a C-shaped composite structure, the mold includes a rigid base made of two mold sections that when joined together form an expansion cavity with a suitable shape for forming a molded composite structure, the mold also includes a cap plate positioned over the expansion cavity and supported at its opposite ends by two mold sections, and a tool core placed inside the expansion cavity and under said cap plate, located inside the expansion cavity and under and around the tool core is a mold cavity that is filled with composite material that when cured forms a composite structure, the improvement comprising:
a heat expandable boot located inside said expansion cavity and below and around said tool core and completely around said mold cavity, said boot being configured to partially absorb the expansion forces exerted by said composite material when heated.

2. The improved mold, as recited in claim 1, further including two side plates and a compression plate located inside said expansion cavity and said boot being located above said compression plate, each said side plate includes a horizontal leg and a vertical leg and an inward aligned beveled edge formed on an end of said horizontal leg, said side plates having a sufficient size and shape to form a mold cavity located below said side plates and said mold parts, said side plates being positioned inside said expansion cavity so that said vertical legs extend upward parallel to a section of said mold cavity and said horizontal legs extend horizontally parallel to a second section of said mold cavity, said bevel edges on said side plate face inward and aligned to form a V-shaped void, said compression plate includes a downward extending V-shaped projection that fits into said V-shaped void that enables said slide plates to moved laterally inside said expansion cavity in response to the downward pressure is exerted on said compression plate and the expansion pressure created by composite material placed into said mold cavity when curing.

3. The mold, as recited in claim 2, further including at least one plug placed into said mold cavity to limit the movement of said side plates against said base.

4. The mold, as recited in claim 3, wherein said plug is made of metal or glass.

5. The improved mold, as recited in claim 1, further including said boot being located inside said expansion cavity and adjacent to the inside surface of said base and said tool core being a sufficient size and shape so that a mold cavity is formed between the tool core and said boot.

6. The improved mold, as recited in claim 1, wherein said boot is made of silicone.
